(19) United States
(12) Patent Application Publication
(10) Pub. No.: US 2021/0370120 A1
(43) Pub. Date: Dec. 2, 2021

(54) UV waste curing system

(71) Applicant: Bret J. Ewin, Round Hill, VA (US)

(72) Inventor: Bret J. Ewin, Round Hill, VA (US)

(21) Appl. No.: 16/873,644

(22) Filed: May 29, 2020

(51) Int. Cl. A62D 3/176; B65F 1/16

(52) U.S. Cl. CPC A62D 3/176; B65F 1/16

(57) ABSTRACT

A method and system for curing and safely disposing of resin-tainted articles is based on a specially configured curing chamber having unique structural and functional means allowing the insertion of the articles, curing of the articles and gravity dropping the articles from the chamber. The resin-tainted or resin-carrying waste articles, such as paper towels, gloves and resin tanks, may be produced as a result of 3D printing and related processes and are safely processed with a minimum amount of user handling in a very compressed time frame. LED sources operating at 405 nm, and other wavelengths, are positioned in the lower surface of a hinged top lid of the chamber and a slidably retractable floor tray retains the articles during curing. On completion of the curing cycle, the articles are gravity dropped by sliding the floor tray to its open position thereby depositing the cured articles into an external trash can for safe disposal.

### TECHNICAL FIELD

The present invention relates generally to methods and apparatus for curing resin tainted articles, and more specifically to a resin curing system configured to efficiently cure and facilitate the disposal of the cured articles. The present unique curing system is configured to accept tainted articles, such as disposable nitrile gloves, paper towels and other consumable, expose them to UV curing radiation in a specialized curing chamber, and subsequently readily disposing of the safe-to-dispose-of articles into a conventional trash can.

### BACKGROUND

Devices and systems for curing resins of the type used in 3D SLA printing and related arts are well known, and it is especially common to employ UV radiation operating at various wavelengths to affect a suitable cure of the materials used. Wavelengths of 365 nm and 405 nm, plus others, are commonly employed. The waste products associated with the printing processes may be made safe to dispose of by causing the waste articles to be exposed to sunlight for several days, sometimes as long as ten days. A low tech but not a time efficient solution.

Regarding the 3D printing environment, typical SLA printer workflow involves removing uncured prints saturated in uncured resin from the SLA printer, washing those uncured prints in solvents, drying those uncured print with compressed air, and baking those uncured prints in a special UV Curing Oven, at which point the cured prints are safe to handle normally. There is also typically a cleaning cycle between prints, where residual uncured resin is removed from select parts of the SLA printer and other work surfaces. The liberal use of consumables such as nitrile gloves and paper towels is the norm, and the amount of resin tainted consumables accumulates rapidly.

Uncured resins are considered a hazardous waste, requiring special waste management handling and disposal procedures, for example the use of separate trash cans, and the storage of said waste until a monthly hazardous waste collection event, where said waste is transported to a remote location. However, cured resins are considered normal household waste, with no special handling or disposal requirements. The use of the present invention ensures all consumables that are tainted with resin during the SLA printer workflow are immediately cured, allowing them to be thrown away like regular trash, avoiding all the typical overheads.

Description of typical prior art approaches to curing resins in this and closely related environments may be found in open literature sources as well as in U.S. patents. The Formlabs article titled “How to safely Dispose of Formlabs Resin” provides a good discussion on how to safely handle their resins, and is accessible via the website at www.3de-shop.com/how-to-safely-dispose of-Formlabs resin/. However, the article contains no teaching of specific apparatus for carrying out the safe disposal. Also, note the language on page 2/4 reciting “allow the container to be exposed to sunlight for around 1 to 10 days.”

A User Manual published by ANYCUBIC describes a device used to “Wash and Cure” articles using both UV LED sources producing 40 watts of radiation at 405 nm (or 365 nm) and a washing fluid (alcohol) but also recites the use of sunlight to cure dissolved resin residue in the alcohol solution. Curing times of two minutes for non-complicated models is recited.

Consider U.S. Pat. No. 5,225,172 to Meyler et al. which discloses apparatus for sterilizing small articles, such as medical instruments, placed in a slideable drawer 20 using UV lamps operating at 257 nm. The UV source is energized upon moving the drawer inwardly into the housing 14, and a timer 30 determines the sterilization time, as described in col. 2, beginning at line 16. While the goal is to sterilize articles, not to cure resins, the structures employed are of interest. The apparatus described includes concave reflectors in the sterilizing area to produce an even amount of ozone from the UV rays.

U.S. Pat. No. 6,880,470 to Sidor et al. is of interest regarding its showing of a waste disposal apparatus adapted for fitting atop a conventional trash container. The device uses a drop slot 3 for inserting waste material which gravity drops into the container.

Note that these prior art patent and literature documents show only various narrowly focused aspects or subcombinations of the features taught in the present invention. More significantly, not one of these prior art references teaches nor suggests the use of a specially configured chamber having an array of UV LEDs in the lower surface of a hingedly connected top lid and a slideable floor tray, which operate to first cure the waste resin-tainted or resin-carrying articles and then gravity ejecting them from the chamber with a minimal amount of handling. It is exactly these needs that the present invention admirably meets.

### OBJECTS OF THE INVENTION

It is therefore a primary object of the present invention to provide improved methods and apparatus for curing and disposing of resin-tainted waste.

An additional object of the present invention is to provide methods and apparatus for rendering resin-carrying waste articles safe to dispose of in a waste stream not requiring special hazardous materials handling.

A further object of the present invention is to provide methods and apparatus for curing resin-tainted articles produced during SLA 3D printing operations by eliminating the special handling and disposal requirements of working with uncured resins.

A still further object of the present invention is to provide apparatus for curing resin-tainted or resin-carrying articles wherein a specially configured chamber is formed to both cure and then dispose of the articles in a conventional trash can without the need for additional handling of the articles.

### BRIEF DESCRIPTION OF THE DRAWINGS

Additional objects and advantages of the invention will become apparent to those skilled in the art as the description proceeds with reference to the accompanying drawings, wherein:

FIG. 1 is a top right front perspective view of a UV Waste Curing System embodying the apparatus features of certain aspects of the present invention;

FIG. 2 is a perspective view of a UV Curing System sized to fit and positioned atop a typical trash can for receiving cured waste products by gravity drop when a floor tray is slid outwardly from the apparatus;

FIG. 3 is an alternate embodiment of the interior surface of a top lid showing a 36 LED array of UV sources;

FIG. 4 is an alternate embodiment of the upper surface of a slideable floor tray showing its mirrored upper surface;

FIG. 5 is an elevational view of a back wall flap door in its closed position; and

FIG. 6 is a perspective view of a back wall flap door in its 90° open position allowing for oversized articles to be placed into its associated chamber.

### BEST MODE FOR CARRYING OUT THE INVENTION

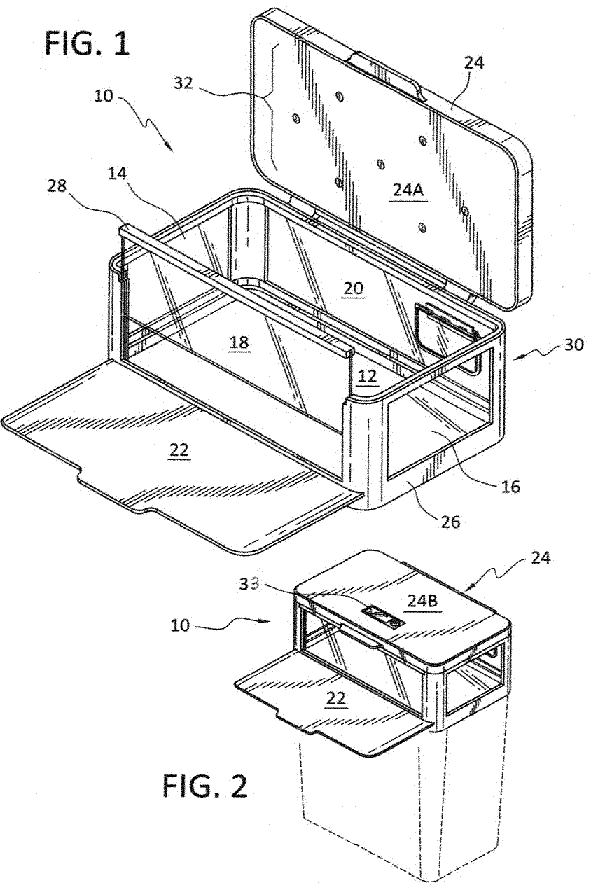

Referring now to FIG. 1, there is shown a perspective view of selected apparatus aspects of a system for curing resins and resin-tainted articles according to the present invention. By way of a brief overview, a UV Curing Assembly 10 is configured to provide a uniquely devised interior chamber 12 within the walls of its generally rectangular shaped container. Left and right side walls 14 and 16 are disposed between front and rear walls 18 and 20. A moveable floor of the chamber is provided in the form of a moveable sliding floor tray 22, and the chamber 12 may be closed at its top by a hinged upper lid 24.

For structural integrity the assembly 10 may be rigidified by means of a frame 26 which carries the elements 14 through 22, and to which the top lid 24 is hingedly attached. The side walls 14 and 16 and front and back walls 18 and 20 may be formed of transparent amber acrylic, to contain UV light as described in detail below. The frame 26 may be formed of any suitably strong and compatible material, such as various types of plastics, woods or composites.

In a baseline preferred embodiment, the front wall 18, which carries a strengthening member 28 at its upper edge, is slidabably retained by the frame 26. It is shown, illustratively, in an intermediate vertical position between its fully closed position (lowered down) and its fully open position (raised up). When the front wall 18 is fully closed, the member 28 cooperates with the frame 26 to increase the rigidity of the assembly 10. In an alternate preferred embodiment (not shown), the member 28 is formed integrally with the front of the frame 26, and the front wall 18 slides up and down within slots in this one piece version responsive to user actuation of a small handle at its top. When fully vertically opened, (or entirely removed temporarily), this front wall 18 position facilitates placing of certain types of articles, such as containers of liquid resin-carrying waste into the chamber 12. This is done by horizontally inserting the containers to rest on the floor tray 22 thereby avoiding the need to tilt the containers thus preventing spillage of their uncured contents. A typical container of this type is a Form Resin Tank generally used in connection with 3D printing.

In the rear wall 20 there is formed a flap door designated generally as 30. Momentary reference to FIG. 5 will give a clear view of this component, and its structure and function will be described in detail in connection with that figure. Now back to FIG. 1, an array of UV sources 32 are positioned on the lower surface of the top lid 24. In a preferred embodiment the array consists of seven sources which are positioned to produce a uniform irradiation of articles placed in the chamber 12 when the top lid 24 is closed as shown in FIG. 2, and the sources are energized. Preferably, the LED sources are UV LEDs operating at a wavelength of 405 nm. Alternate preferred embodiments of the LED array are described below including more numerous sources, and operating at wavelengths of 365 nm, plus others. In use, the top lid 24 swings open upwardly and out of the way by hinge action and the floor tray 22 is pushed closed to allow the chamber 12 to be filled with resin-tainted consumables/articles. When the top lid 24 is closed, the UV sources are turned on for a period of time. The walls 14, 16, 18 and 20 are made of transparent amber acrylic, which blocks the 405 nm UV light, but allows the user to view the curing process safely. When the resin on the consumables/articles is sufficiently cured, the floor tray 22 is pulled forward to its open position allowing the articles to gravity drop directly into the trash can.

Note that resin-tainted consumables such as paper towels may occasionally stick to the top surface of floor tray 22, due to a thin layer of resin curing against that surface. This case is addressed using a simple scraping edge (not shown) along the inside portion of frame 26, specifically along the thin lower portion of wall 18 directly under which the floor tray slides. This scraping edge will gently scrape the top of floor tray 22 as it slides out, unseating any stuck consumables, while also preventing any consumables from exiting chamber 12 unexpectedly. This scraping edge also serves to block any light from escaping the curing area along the top of the floor tray.

Turning now to FIG. 2, the assembly 10 is shown as it would be generally positioned in regular use as sitting atop a commonly available trash can. While the trash can forms no part of the present invention, it complements the gravity drop feature provided. Note that the floor tray 22 is shown as being full extended, or in its open position, allowing the articles in the chamber 12 to drop by gravity into a trash can or other suitable receptacle. This feature is highly useful as it minimizes the number of times the consumable articles being cured need to be handled. On the top or upper surface of the lid 24 is found a control panel 33 having knobs and indicators as required to carry out the desired curing cycles. Control circuitry and related elements (not shown) are housed in the volume between lower and upper surfaces 24A and 24B of top lid 24. A typical curing cycle is carried out by energizing the UV sources at 405 nm at a power level allowing the tainted consumables to be cured almost immediately, so the invention can keep up with typical frequency of trash production in an SLA printer workflow.

The floor tray 22 can be fully opened, or temporarily removed, to allow the UV light to also cure materials in the trash can. This is useful when curing larger items that do not fit well into the curing chamber, or to apply a longer curing time to consumables that have been transferred to the trash can prematurely.

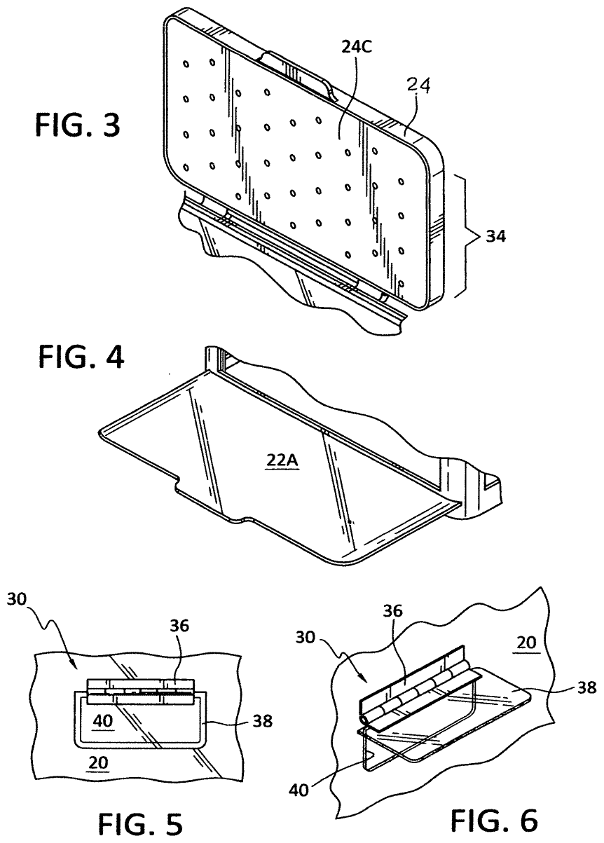

The perspective view of FIG. 3 shows an alternate preferred embodiment of the top lid 24 which carries a more extensive array of UV sources on its lower surface. The alternate array 34 consists of 36 LEDs arranged, illustratively, in 9 columns of 4 LEDs each. This arrangement provides a homogeneous radiation pattern and may operate at a suitable power level at the wavelengths of 365 nm or 405 nm, as well as in the range between 750-1400 nm.

FIG. 4 shows an alternate preferred embodiment of the floor tray 22 of FIG. 2 as having a mirrored upper surface 22A. Taken by itself or in combination with the lower surface 24C of FIG. 3, which may also be mirrored, the mirrored surface(s) improve the curing efficiency of the process. The increased efficiency derives from causing the articles to be subjected to UV radiation from multiple directions due to the multipath reflections produced by the mirror(s). When so operated, curing times for typical batches of waste may be greatly reduced, in some cases being a matter of seconds.

FIG. 5 is an elevational view of the back wall flap door 30 shown as having a piano hinge 36 from which is suspended a flap door 38. In its closed position the door 38 covers a similarly shaped, but slightly smaller, opening 40 in the back wall 20. These relative sizes assure that no UV light can escape when flap door 38 is closed. The door 38, as well as its hinge 36, are made transparent amber acrylic to both allow the user to see inside as well as to maintain a pleasing visual esthetic. The door 38 is normally maintained in its closed position by conventional biased hinging means included within the hinge structure.

In use, the flap door 38 is urged upon open by oversized articles being inserted into the chamber 12 to take on the open position shown in the perspective view of FIG. 6. There, the door 38 is shown urged open (backward) by about 90° allowing the oversized article (not shown), or a protrusion from it, to partially fit within the chamber 12 thanks to the opening 40 in the back wall 20. An illustrative oversized article commonly found in 3D printing is a Formlabs Form 3 Resin Tank.

Although the invention has been described in terms of preferred and alternate embodiments, the invention should not be deemed limited thereto since modifications will readily occur to one skilled in the art. For example, the array of UV LEDs may be arranged in various rows and columns as well as being substituted for by a single UV source with a distributed pattern, and the mirrored surfaces may be omitted or patterned. It is therefore to be understood that the appended claims are intended to cover all such modifications as fall within the true spirit and scope of the invention.

1. A system for curing resin-carrying waste articles using UV radiation, comprising:
(a) a housing having a hingedly affixed top lid and a slideable bottom tray vertically disposed between front, back and side walls;
(b) an LED array affixed to a lower surface of said top lid for irradiating resin-carrying articles placed within said housing;
(c) said top lid moveable between a closed position which forms a ceiling of said housing and an open position allowing articles to be placed therein;
(d) said bottom tray slideable between a closed position which forms a floor of said housing and an open position allowing articles to exit by gravity therefrom; and
(e) whereby upon placing said articles into said housing with said bottom tray closed and said top lid closed and energizing said LED array, efficient curing of said articles is carried out rendering them safe to dispose of.

2. The system of claim 1 wherein said front, back and side walls are formed in substantial part of transparent amber acrylic and said LED array consists of a plurality of distinct sources systematically arrayed on a lower interior surface of said top lid.

3. The system of claim 2 wherein said back wall further comprises a flap door hingedly arranged to cover a correspondingly shaped smaller opening in said wall which allows oversized articles to fit within said housing.

4. The system of claim 3 wherein a lower surface of said top lid and an upper internal surface of said bottom floor tray are mirror surfaces thereby increasing the curing efficiency of said LED sources.

5. The system of claim 3 wherein said LED array produces light at at least one wavelength selected from the range including 365 nm, 405 nm and 750-1400 nm.

6. The system of claim 1 wherein said front wall is vertically slidable between a closed position and an open position thereby facilitating the insertion of articles by horizontal sliding into said housing when in the open position.

7. The system of claim 1 wherein said front wall is vertically removable thereby facilitating the insertion of certain articles by being horizontal slid into said housing.

8. A UV curing system for efficiently curing resin-carrying waste articles, comprising:
(a) an interior curing chamber formed in part by being positioned between an upper top lid and a lower floor tray;
(b) said chamber further formed by being positioned between front, back and side walls whereby said lid, tray and walls define a volumetric extent of said chamber;
(c) said lid hingedly connected to an upper edge of said back wall and having at least one LED on its lower surface;
(d) said lid being moveable between a closed positon forming a ceiling of said chamber and an open position allowing articles to be placed therein;
(e) said lower tray slideably positioned between said side walls and moveable between a closed position forming a floor of said chamber and an open position allowing the contents in said chamber to exit the system by gravity drop; and
(f) whereby, upon placing resin-carrying articles into said chamber with said lower tray closed and closing said top lid and energizing said at least one LED, efficient curing of said articles is accomplished.

9. The UV curing system of claim 8 wherein said front, back and side walls are formed in substantial part of transparent amber acrylic and are curved to produce a chamber not strictly rectangular in horizontal cross section.

10. The UV curing system of claim 8 wherein said at least one UV LED comprises a plurality of UV LED sources systematically arrayed on a lower interior surface of said top lid.

11. The UV curing system of claim 8 wherein said back wall further comprises a flap door hingedly arranged to cover a correspondingly shaped smaller opening in said wall which allows oversized articles to fit within said chamber.

12. The UV curing system of claim 9 wherein a lower surface of said top lid and an upper internal surface of said bottom floor tray are mirror surfaces thereby increasing the curing efficiency of said UV sources.

13. The UV curing system of claim 8 wherein said front wall is vertically slidable between a closed position and an open position thereby facilitating the insertion of articles by horizontal sliding into said chamber when in the open position.

14. The UV curing system of claim 8 wherein said front wall is vertically removable thereby facilitating the insertion of certain articles by horizontal sliding into said chamber.

15. A method of curing hazardous resin-carrying waste articles at their point of use thereby rendering them safely disposable as common household waste with no special safety or disposal requirements, the method minimizing the amount of manual handling of said articles, including the steps of:
(a) providing a curing chamber having a top lid, a lower tray and front, back and side walls;
(b) said top lid having at least one UV LED on its lower surface and moveable between a closed position forming a ceiling of said chamber and an open position allowing articles to be placed therein;
(c) said lower tray slideably moveable between a closed position forming a floor of said chamber and an open position allowing articles in said chamber to exit therefrom by gravity drop;
(d) placing said articles into said chamber via an opened lid and retained therein by a closed lid and closed tray;
(e) energizing said at least one UV LED to cure said articles: and
(f) moving said tray to its open position causing cured articles to be ejected from said chamber for disposal.

16. The method of claim 15 wherein said chamber is formed by being positioned between a hinged top lid and a slideable lower floor tray and further between said front, back and side walls whereby said lid, tray and walls define a volumetric extent of said chamber;

17. The method of claim 15 wherein said back wall further comprises a substantially rectangular flap door hingedly arranged to cover a correspondingly shaped smaller opening in said wall thereby allowing oversized articles to fit within said chamber.

18. The method of claim 15 wherein said at least one UV LED comprises a plurality of UV LED sources systematically arrayed on said lower surface of said top lid.

19. The method of claim 15 wherein a lower surface of said lid and an upper surface of said tray are mirrored surfaces thereby increasing the curing efficiency of said chamber.

20. The method of claim 18 wherein said LED array produces light at at least one wavelength selected from the range including 365 nm, 405 nm and 750-1400 nm.
